(19) United States
(12) Patent Application Publication
(10) Pub. No.: US 2014/0312738 A1
(43) Pub. Date: Oct. 23, 2014

(54) ULTRASONIC MOTOR

(71) Applicants: Akihiro Suzuki, Kariya-shi (JP); Shinya Asai, Kariya-shi (JP); Masaki Takasan, Kariya-shi (JP); Kanji Erami, Kariya-shi (JP)

(72) Inventors: Akihiro Suzuki, Kariya-shi (JP); Shinya Asai, Kariya-shi (JP); Masaki Takasan, Kariya-shi (JP); Kanji Erami, Kariya-shi (JP)

(73) Assignee: KABUSHIKI KAISHA TOYOTA JIDOSHOKKI, Kariya-shi, Aichi (JP)

(21) Appl. No.: 14/357,093

(22) PCT Filed: Jul. 30, 2012
(86) PCT No.: PCT/JP2012/069321

§ 371 Date: May 8, 2014

(30) Foreign Application Priority Data
Nov. 9, 2011 (JP) 2011-245673

(51) Int. Cl. H02N 2/00

(52) U.S. Cl. CPC H02N 2/0065
USPC 310/323.02

(57) ABSTRACT

A rotor 2 of an ultrasonic motor 1 is pressed to make contact with a pair of supporting parts 11, 12 of a stator 3. Contact surfaces 21, 22 are formed respectively following the shape of an outer circumferential surface 2b of the rotor 2, in the upper portions of the supporting parts 11, 12. Since different level sections 23, 25 are formed in the contact surface 21, and different level sections 24, 25 are also formed in the contact surface 22, the contact distance between the rotor 2 and the stator 3 is limited.

### TECHNICAL FIELD

This invention relates to an ultrasonic motor, and more particularly, to the construction of a contact section between a moving element and a fixed element in an ultrasonic motor.

### BACKGROUND ART

In recent years, ultrasonic motors have been achieved, in which piezoelectric elements, or the like, are used to generate ultrasonic vibrations in a stator (fixed element), and a rotor (moving element) that is in press contact with the stator is made to perform rotational movement or linear movement by the frictional force between the two members. Patent Document 1, for example, describes a vibration actuator (ultrasonic motor) in which a spherical rotor is arranged in a recess section formed on one end of a stator. The rotor is in press contact with a circular ring-shape corner section on an open end of the recess section of the stator, and the rotor is made to perform rotational movement by the frictional force between this corner section and the rotor. Furthermore, a lubricant, such as grease, is accommodated inside the recess section of the stator, and this lubricant is supplied between the stator and the rotor.

### PRIOR ART DOCUMENT

### Patent Document

Patent Document 1: Japanese Patent Application Publication No. 2008-206251

### SUMMARY OF THE INVENTION

### Problems to be Solved by the Invention

As a drive force is achieved by using the frictional force between the rotor and stator, the members of the ultrasonic motor wear over time, and it is known that wear occurs in the stator of the piezoelectric actuator described in Patent Document 1. More specifically, in the case of the piezoelectric actuator described in Patent Document 1, the corner sections of the recess section of the stator wear into a shape corresponding to the spherical rotor. In this case, the contact surface area between the rotor and the stator becomes greater as wear progresses, and therefore variations also occur in the drive force of the rotor due to the stator. Furthermore, the vibration actuator described in Patent Document 1 supplies lubricant between the rotor and stator, but since the surface pressure between these members varies with an increase in the contact surface area, it is not possible to maintain an appropriate surface pressure as the wear progresses, and the required drive force can no longer be obtained. In this way, the piezoelectric actuator described in Patent Document 1 has a problem in that large variations in the drive force occur as wear of the stator progresses.

The present invention was devised in order to resolve problems of this kind, an object thereof being to provide an ultrasonic motor which suppresses increases in the contact surface between the moving element and the fixed element, as wear progresses, and which achieves reduction of variations in the drive force.

### Means for Solving the Problems

The ultrasonic motor related to the present invention includes: a moving element which performs rotational movement or linear movement; a fixed element which has a contact surface capable of making surface contact with the moving element and which causes the moving element to move; a pre-loading means which presses the moving element against the fixed element; and a vibration means which causes the moving element to move by generating ultrasonic vibrations in the fixed element, wherein a different level section is formed in the fixed element so as to form a gap between the fixed element and the moving element.

### Effects of the Invention

According to this invention, increases in the contact surface area between the moving element and the fixed element as wear progresses are suppressed, and variations in the drive force can be reduced.

### BRIEF DESCRIPTION OF THE DRAWINGS

FIG. 1 is a cross-sectional side view showing the composition of an ultrasonic motor relating to a first embodiment of the present invention.

FIG. 2 is a partial enlarged cross-sectional diagram showing a principal part of the ultrasonic motor relating to the first embodiment.

FIG. 3 is a partial enlarged cross-sectional diagram showing a principal part of the ultrasonic motor relating to the first embodiment.

FIG. 4 is a perspective diagram showing the composition of the ultrasonic motor relating to a second embodiment of the present invention.

FIG. 5 is a partial enlarged cross-sectional diagram showing a modification example of the embodiment relating to this invention.

FIG. 6 is a partial enlarged cross-sectional diagram showing a principal part of an ultrasonic motor relating to another embodiment of the present invention.

FIG. 7 is a partial enlarged cross-sectional diagram showing a principal part of an ultrasonic motor relating to another embodiment of the present invention.

FIG. 8 is a partial enlarged cross-sectional diagram showing a principal part of an ultrasonic motor relating to another embodiment of the present invention.

FIG. 9 is a partial enlarged cross-sectional diagram showing a principal part of an ultrasonic motor relating to another embodiment of the present invention.

### BEST MODE FOR CARRYING OUT THE INVENTION

Below, embodiments of the invention are described with reference to the accompanying drawings.

### First Embodiment

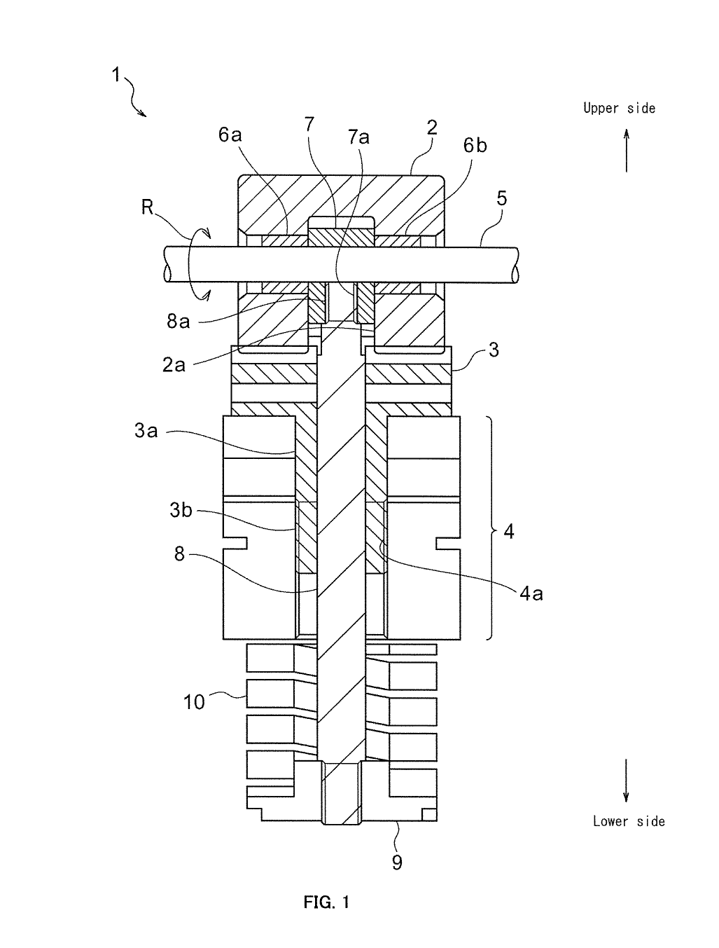

FIG. 1 shows an ultrasonic motor 1 relating to a first embodiment of the invention. For the purposes of the description given below, the vertical direction in the ultrasonic motor 1 is indicated by the arrows shown in FIG. 1, and so on.

The ultrasonic motor 1 causes a rotor 2, which is a moving element having a substantially cylindrical shape, to perform rotational movement about an axial direction (see arrow R) by using ultrasonic vibrations, and includes a stator 3 which is a fixed element that is in contact with the rotor 2, and a piezoelectric element 4, which is a vibration means that generates ultrasonic vibrations in the stator 3. In the present embodiment, the direction of rotation of the rotor 2 corresponds to the direction of movement.

The stator 3 is fixed to the piezoelectric element 4 by a male screw thread 3b formed on a shaft section 3a engaging with a female screw thread 4a formed on an inner circumference section of the piezoelectric element 4. Furthermore, the stator 3 and the piezoelectric element 4 have a substantially cylindrical shape overall, and are arranged in such a manner that the axial direction of the rotor 2 and the axial direction of the stator 3 and the piezoelectric element 4 are mutually orthogonal. The piezoelectric element 4 is formed by laminating together a plurality of piezoelectric element plates, and by applying an AC voltage to these piezoelectric element plates from a drive circuit (not shown), ultrasonic vibrations are generated in the stator 3.

A shaft 5 is provided to pass through the central portion of the rotor 2 along the axial direction, and the shaft 5 is supported rotatably by bearings 6a, 6b provided inside the rotor 2. Furthermore, an opening section 2a which opens to the lower side is formed in an intermediate section of the axial direction of the rotor 2, and a holding member 7 surrounding the outer circumference section of the shaft 5 is accommodated inside the opening section 2a. The holding member 7 is a member for coupling a rod 8 passing through the stator 3 and the piezoelectric element 4, to the shaft 5. The holding member 7 and the rod 8 are fixed by means of a male screw thread 8a formed on the outer circumference section of the rod 8 engaging with a female screw thread 7a formed on the holding member 7, and the upper end portion of the rod 8 is abutted against the outer circumferential surface of the shaft 5.

On the other hand, a pre-load nut 9 is attached to the lower end section of the rod 8 which extends to the lower side of the piezoelectric element 4, and a pre-load spring 10 is provided between the piezoelectric element 4 and the pre-load nut 9. The pre-load spring 10 is held between the piezoelectric element 4 and the pre-load nut 9 in a state of compression by a prescribed load, whereby the rotor 2 is impelled towards the lower side and is pressed against the stator 3. More specifically, the rotor 2 relating to this embodiment rotates while rubbing against the stator 3, and the direction of rubbing of the rotor 2 and the direction of rotation indicated by arrow R match. Here, the holding member 7, rod 8, pre-load nut 9 and pre-load spring 10 constitute a pre-loading means in the ultrasonic motor 1.

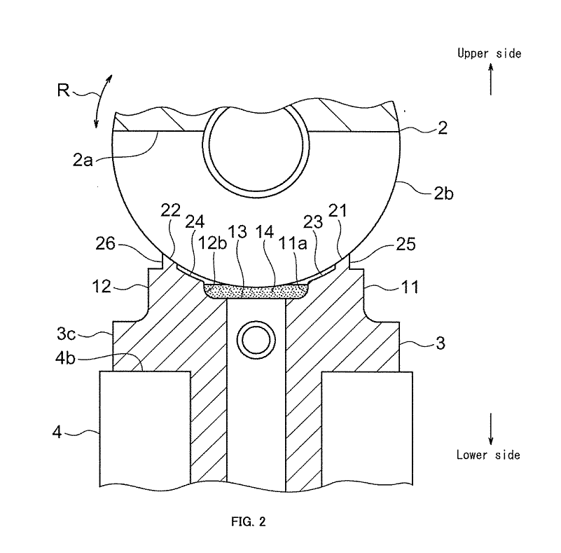

As shown in FIG. 2, the stator 3 has a cylindrical head section 3c which is arranged between the rotor 2 and the upper surface 4b of the piezoelectric element 4. A pair of supporting parts 11 and 12 extending linearly along the depth direction in FIG. 2, in other words, the axial direction of the rotor 2, are formed to project towards the upper side, and a rotor 2 is arranged on the supporting part 11 and the supporting part 12. Furthermore, a lubricant supply body 14 is provided inside a recess section 13 which is formed between the supporting part 11 and the supporting part 12. The supply body 14 is a member having a substantially cuboid shape made from a porous resin having flexible properties, which is impregnated with a lubricant, such as oil or grease, and is provided so as to make contact with the outer circumferential surface 2b, which is constituted by the side face 11a of the supporting part 11, the side face 12b of the supporting part 12, and the outer surface of the rotor 2.

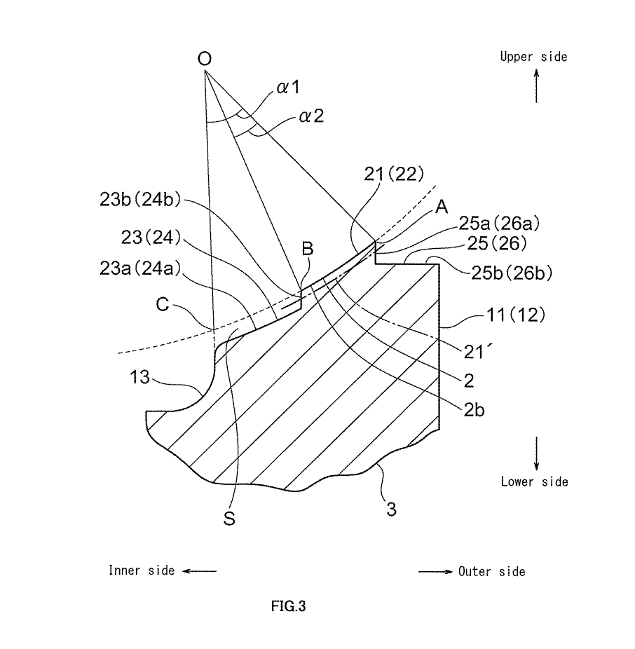

Here, the composition of the contact section between the rotor 2 and the stator 3 is described in detail with reference to FIG. 3 which shows one side of the supporting parts 11 of the stator 3. Since the supporting part 11 and the other supporting part 12 have the same construction, the constituent elements of the side of the supporting part 12 are shown with reference numerals inside brackets in FIG. 3 and description of the side of the supporting part 12 is omitted here.

As shown in FIG. 3, the upper portion of the supporting part 11 is formed so as to have a circular arc-shaped cross-section along the outer circumferential surface 2b of the rotor 2, and the upper surface of the supporting part 11 constitutes the contact surface 21 which can make surface contact with the outer circumferential surface 2b of the rotor 2. Furthermore, a minimal different level section 23 is provided in the contact surface 21 to form a gap S with respect to the outer circumferential surface 2b of the rotor 2, in a portion on the side near the central axis of the stator 3, in other words, on the inner side.

The different level section 23 is provided so as to have a clearance of approximately 0.1 mm, for example, from the outer circumferential surface 2b of the rotor 2, in such a manner that the peripheral shape of the contact surface 21 of the stator 3 does not vary greatly. Consequently, by forming the different level section 23, effects on the vibration mode of the ultrasonic motor 1 can be avoided. Furthermore, the side wall surface 23b, which links the bottom forming surface 23a of the different level section 23 with the contact surface 21, is formed so as to extend along the direction in which the rotor 2 is pressed against the stator 3, in other words, along the vertical direction.

By providing this different level section 23, the contact surface 21 of the stator 3 makes contact with the outer circumferential surface 2b of the rotor 2 between the edge portion A positioned on the outer side (upper side) and the edge portion B positioned on the inner side (lower side). Here, if the different section 23 is not provided, then the outer circumferential surface 2b of the rotor 2 and the contact surface 21 of the stator 3 make contact between the edge portion A and the virtual edge portion C shown in FIG. 3. In other words, by providing the different level section 23 in the contact surface 21, a state is achieved in which the contact distance between the outer circumferential surface 2b of the rotor 2 and the contact surface 21 of the stator 3 is limited to the distance between the edge portion A and the edge portion B. Furthermore, by limiting the contact distance in this way, the contact angle between the rotor 2 and the contact surface 21, in other words, the angle between a straight line linking the center O of the rotor 2 and the edge portion A of the contact surface 21, and a straight line linking the center O of the rotor 2 and the edge portion B, is an angle α2, which is smaller than the angle α1 when the different level section 23 is not provided.

A different level section 25 in which a portion positioned to the outer side from the edge portion A is cut away is formed in the contact surface 21 on the side far from the central axis of the stator 3, in other words, on the outer side thereof. The side wall surface 25a forming this different level 25 is formed along a direction towards the lower side from the edge portion A of the contact surface 21, in other words, the direction in which the rotor 2 is pressed against the stator 3, and the bottom forming surface 25b is formed so as to extend towards the outer side from the lower end portion of the side wall surface 25a. Here, the direction in which the rotor 2 is pressed against the stator 3 is a direction towards the lower side. Consequently, if the contact surface 21 of the stator 3 wears with the rotation of the rotor 2, then the wear proceeds towards the lower side as indicated by the single-dotted line shown by reference numeral 21′ in FIG. 3. On the contact surface 21 which proceeds to wear in this way, the side wall surface 23b of the different level section 23 and the side wall surface 25a of the different level section 25 are formed so as to extend towards the lower side from the edge portion A and the edge portion B. In other words, in the present embodiment, the side wall surface 23b and the side wall surface 25a are formed at either end of the stator 3 in the direction of rubbing against the rotor 2. Therefore, even if the contact surface 21 of the stator 3 wears with the rotation of the rotor 2, the surface area does not increase, and the rotor 2 and the stator 3 can contact each other with a uniform surface area at all times.

Next, the operation of the ultrasonic motor 1 relating to the first embodiment of the invention will be described.

As shown in FIG. 1, an AC voltage is first applied to the plurality of piezoelectric element plates of the piezoelectric element 4, from a drive circuit (not shown). If an AC voltage is applied, ultrasonic vibrations are generated in mutually different directions of vibration, in each of the piezoelectric element plates of the piezoelectric element 4, and these ultrasonic vibrations combine together and are transmitted to the stator 3. When the ultrasonic vibrations are transmitted to the stator 3 in this way, an ultrasonic elliptical vibration about the axial direction of the rotor 2 indicated by the arrow R is generated in the supporting part 11 and the supporting part 12 of the stator 3. The ultrasonic elliptical vibrations generated in the supporting part 11 and the supporting part 12 are transmitted to the rotor 2 via the frictional force acting between the contact surface 21 of the supporting part 11 and the contact surface 22 of the supporting part 12, and the outer circumferential surface 2b of the rotor 2, whereby the rotor 2 rotates in the direction indicated by arrow R.

When the rotor 2 rotates, the lubricant with which the supply body 14 in the recess section 13 of the stator 3 is impregnated adheres to the outer circumferential surface 2b of the rotor 2, and is supplied in between the outer circumferential surface 2b and the contact surface 21 of the supporting part 11 and between the outer circumferential surface 2b and the contact surface 22 of the supporting part 12. Here, a minimal different level section 23 and a minimal different level section 24 are formed respectively on the inner side of the contact surface 21 and the inner side of the contact surface 22. These different level sections 23, 24 function as oil grooves for drawing in the lubricant supplied from the lubricant supply body 14, in between the outer circumferential surface 2b of the rotor 2 and the contact surfaces 21, 22, and therefore lubricant can be supplied efficiently to the rotor 2 and the stator 3, in addition to which the friction between the members is reduced and durability can be improved. Furthermore, since the lubricant is supplied to the contact surfaces 21, 22 by the supply body 14, then the rubbing motion of the rotor 2 is smooth and variations in the drive force due to friction can also be suppressed.

In an ultrasonic motor 1 which operates in this way, the rotor 2 rotates due to frictional force with the stator 3, and therefore these members wear over time, in which case wear occurs in the stator 3. Furthermore, when manufacturing the rotor 2 and the stator 3, the members are processed within a prescribed range of dimensional accuracy, and hence variations occur in the respective dimensions. To give a more concrete explanation, the contact surface 21 and the contact surface 22 of the stator 3 are formed so as to have a shape following the outer circumferential surface 2b of the rotor 2, but due to variations in the dimensions during manufacture, there are differences in the state of contact between the outer circumferential surface of the rotor 2 and the contact surface 21 and the contact surface 22 of the stator 3 immediately after assembly of the ultrasonic motor 1.

More specifically, if the diameter of the rotor 2 is greater than the diameter of the contact surface 21 and the contact surface 22 of the stator 3, then the rotor 2 immediately after assembly contacts the contact surface 21 and the contact surface 22 on the upper side, that is, the side of the edge portion A shown in FIG. 3, and rises up above the lower side, that is, the side of the edge portion B. Conversely, if the diameter of the rotor 2 is smaller than the diameter of the contact surface 21 and the contact surface 22 of the stator 3, then the rotor 2 immediately after assembly contacts the contact surface 21 and the contact surface 22 on the lower side (the side of the edge portion B), and rises up above the upper side (the side of the edge portion A). Since this difference in the state of contact is substantially uniform, then generally, when the ultrasonic motor 1 is manufactured, a conditioning operation is carried out for a prescribed period of time to cause the contact surfaces 21, 22 of the stator 3 to wear, in such a manner that contact is made on all surfaces.

Here, as shown in FIG. 3, different level sections 23, 24 are provided in the contact surface 21 of the supporting part 11 and the contact surface 22 of the supporting part 12, in a position on the inner side (lower side), and the contact distance between the contact surfaces 21, 22 and the outer circumferential surface 2b of the rotor 2 is limited to the distance between the edge portion A and the edge portion B. Consequently, compared to a case where the different level section 23 is not provided, it is possible to shorten the time from a state where the rotor 2 and the contact surfaces 21, 22 make contact on one side of the edge portions A, B only, and rise up on the other side, until the rotor 2 and the contact surfaces 21, 22 make surface contact on all surfaces. Furthermore, by limiting the contact distance between the contact surfaces 21, 22 and the outer circumferential surface 2b of the rotor 2, a state is achieved in which there is little change in the contact surface area and the contact angle α2 from immediately after assembly of the ultrasonic motor 1 until the rotor 2 and the contact surfaces 21, 22 make surface contact, and therefore it is possible to keep the drive force of the ultrasonic motor 1 after completion of the conditioning operation, within the prescribed range.

Moreover, in the different level section 23 and the different level 25 of the contact surface 21, the side wall surface 23b and the side wall surface 25a are formed to extend towards the lower side, which is the direction in which the rotor 2 is pressed against the stator 3. Therefore, even if the contact surface 21 wears as indicated by the single-dotted broken line 21′, in accordance with the rotation of the rotor 2, there is no change in the contact distance between the rotor 2 and the contact surface 21, in other words, the distance from edge portion A to edge portion B, and consequently, there is no great variation in the contact surface area or the contact angle α2. Consequently, no great variation occurs in the drive force of the rotor 2 due to the stator 3, or the surface pressure between the rotor 2 and the contact surfaces 21, 22 of the stator 3, and therefore even if wear progresses on the contact surfaces 21, 22, it is possible to reduce variations in the drive force of the ultrasonic motor 1.

As described above, since a different level section 23, a different level section 24, a different level section 25 and a different level section 26 are provided in the contact surface 21 and the contact surface 22 of the stator 3, and the contact distances between the outer circumferential surface 2b of the rotor 2 and the contact surfaces 21, 22 are limited, then even if the contact surfaces 21, 22 wear, increases in the contact surface area with the rotor 2 are suppressed. Consequently, there is little variation in the drive force of the ultrasonic motor 1.

Moreover, if the side wall surfaces 23b, 24b of the different level sections 23, 24 and the side wall surfaces 25a, 26a of the different level sections 25, 26 are formed to extend in the direction in which the rotor 2 is pressed against the stator 3 as in the ultrasonic motor 1, then there is little increase in the contact surface area between the rotor 2 and the contact surfaces 21, 22, due to the progress of wear of the contact surfaces 21, 22. More specifically, it is possible to make variations in the drive force of the ultrasonic motor 1 even smaller.

### Second Embodiment

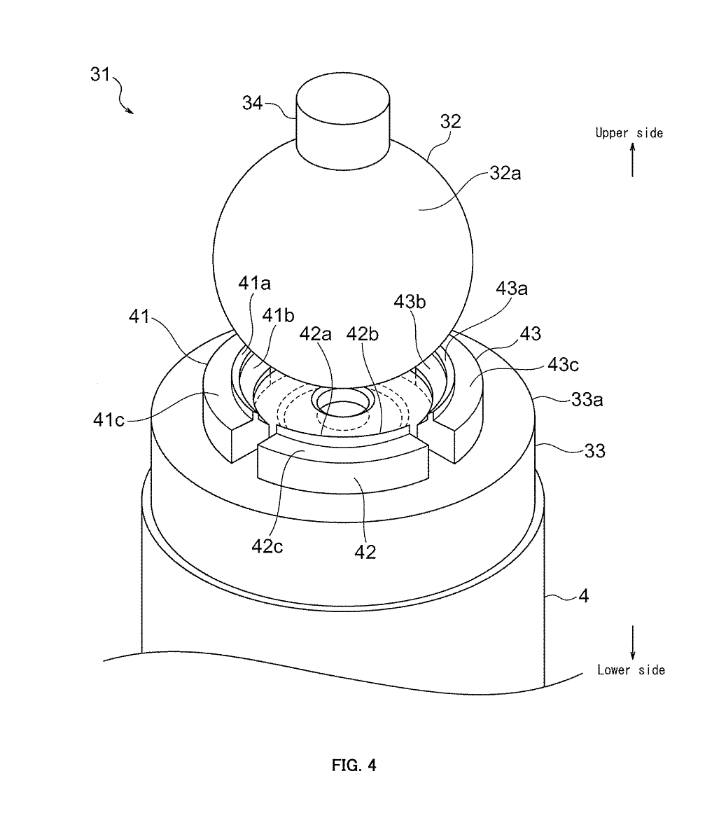

Next, an ultrasonic motor 31 relating to a second embodiment of the invention is described with reference to FIG. 4. In the ultrasonic motor 31 relating to this second embodiment, the shape of the rotor, which is the moving element, is changed with respect to the ultrasonic motor 1 relating to the first embodiment. Furthermore, in the second embodiment which is described below, reference numerals which are the same as the reference numerals shown in FIGS. 1 to 3 indicate the same or similar constituent elements, and detailed description thereof is omitted here.

As shown in FIG. 4, the ultrasonic motor 31 is provided with a rotor 32, which is a spherical body, and a stator 33, which is a fixed element with which the rotor 32 makes contact, and the rotor 32 is pressed against the stator 33 by a pre-loading means 34 which is arranged above the rotor 32. The rotor 32 can perform universal free movement due to the ultrasonic vibrations generated in the stator 33 by the piezoelectric element 4. The stator 33 has a head section 33a which is disposed between an upper part of the piezoelectric element 4 and the rotor 32. Three supporting parts 41 to 43 formed in a substantially circular ring shape are provided so as to project towards the upper side on the upper surface of the head section 33a, and spherical contact surfaces 41a to 43a corresponding to the outer circumferential surface 32a of the rotor 32 are formed on the upper part of the supporting parts 41 to 43.

In these contact surfaces 41a to 43a, different level sections 41b to 43b similar to the different level sections 23, 24 in the first embodiment are formed respectively in positions on the side near the central axis of the stator 33, in other words, on the inner circumferential side. Furthermore, different level sections 41c to 43c similar to the different level sections 25, 26 in the first embodiment are formed in positions on the side far from the central axis of the stator 33, in other words, on the outer circumferential side. More specifically, the supporting parts 41 to 43 of the stator 33 are circular ring-shaped portions having a cross-sectional shape similar to that of the supporting parts 11, 12 in the first embodiment. The remainder of the construction is similar to the first embodiment.

As described above, even if the ultrasonic motor 31 is composed so as to include a spherical rotor 32, then it is possible to achieve beneficial effects similar to the first embodiment, and more specifically, to reduce variation in the drive force as a result of wear of the contact surfaces 41a to 43a of the stator 33.

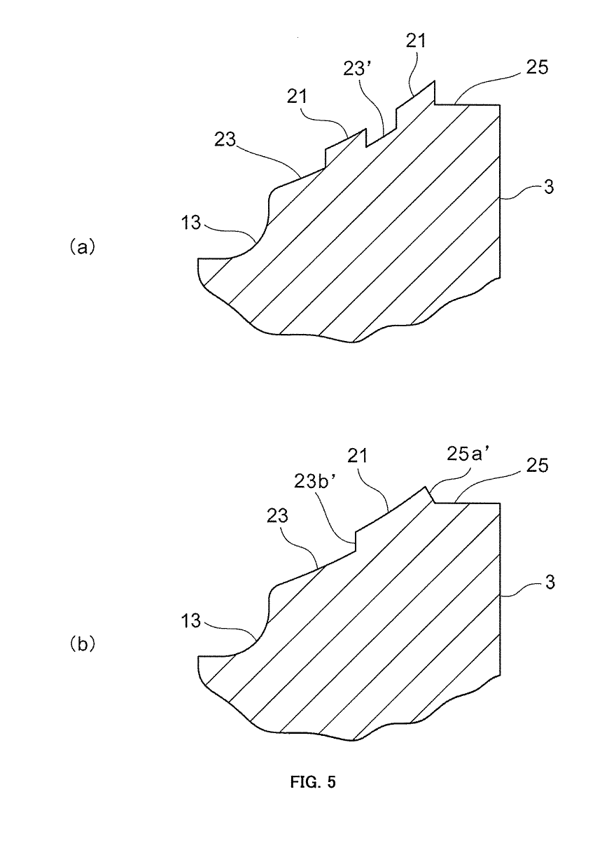

The stators according to the first and second embodiments are constructed in such a manner that different level sections are provided on the inner side and the outer side of the contact surfaces, but the positions where the different level sections are provided are not limited to this. It is also possible to adopt another cross-sectional shape, provided that the shape of the stator is not altered greatly, and it is also possible to provide an additional different level section 23′ in an intermediate section of the contact surface 21, as shown in FIG. 5A, for example.

Furthermore, in the different level sections of the stators according to the first and second embodiments, the side wall surfaces are formed so as to extend in a direction in which the rotor is pressed against the stator, in other words, the vertical direction, but it is also possible to form the side wall surfaces so as to form a prescribed angle with respect to the vertical direction, as in the side wall surface 23b′ and the side wall surface 25a′ shown in FIG. 5B, for example. In this case also, increase in the contact surface area between the rotor and the stator as the wear of the stator progresses is reduced, and therefore it is also possible to obtain substantially beneficial effects similar to the first and second embodiments.

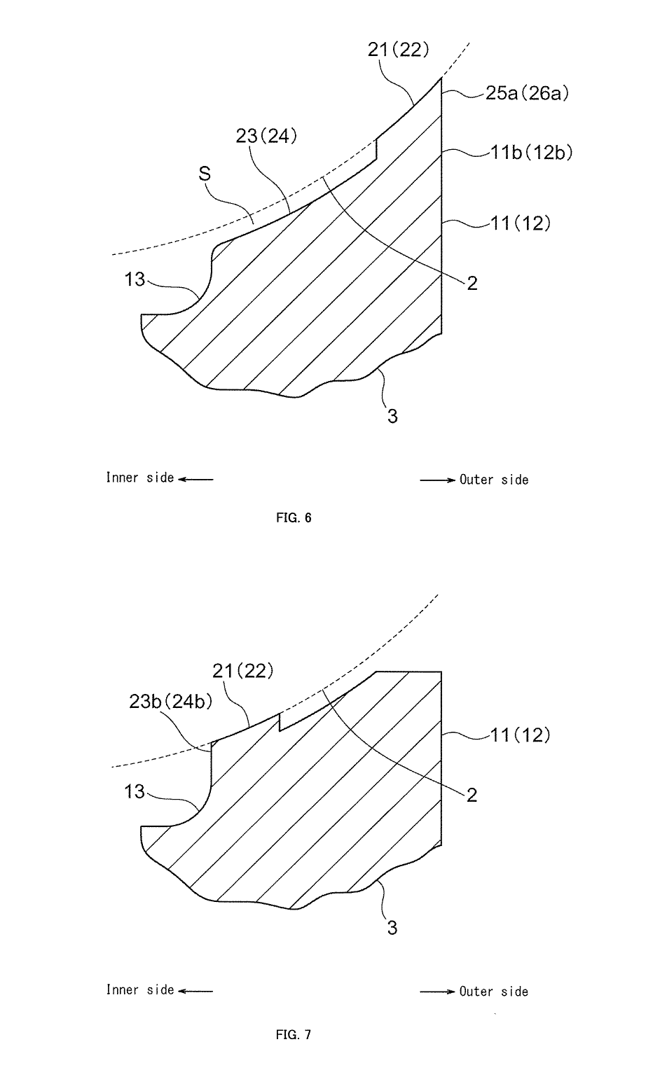

In the stator 3 of the first embodiment, as shown in FIG. 6, the contact surfaces 21, 22 may be formed on the outer sides of both supporting parts 11, 12. In this case, the side wall surface 25a (25b) and the side face 11b of the supporting part 11 (the side face 12b of the supporting part 12) may be formed on the same line.

Moreover, as shown in FIG. 7, the contact surfaces 21, 22 may also be formed so as to be adjacent to the recess section 13, on the inner sides of the supporting parts 11, 12. In this case, the side face 11a forming the recess section 13 and the side wall surface 23b may also be formed on the same line.

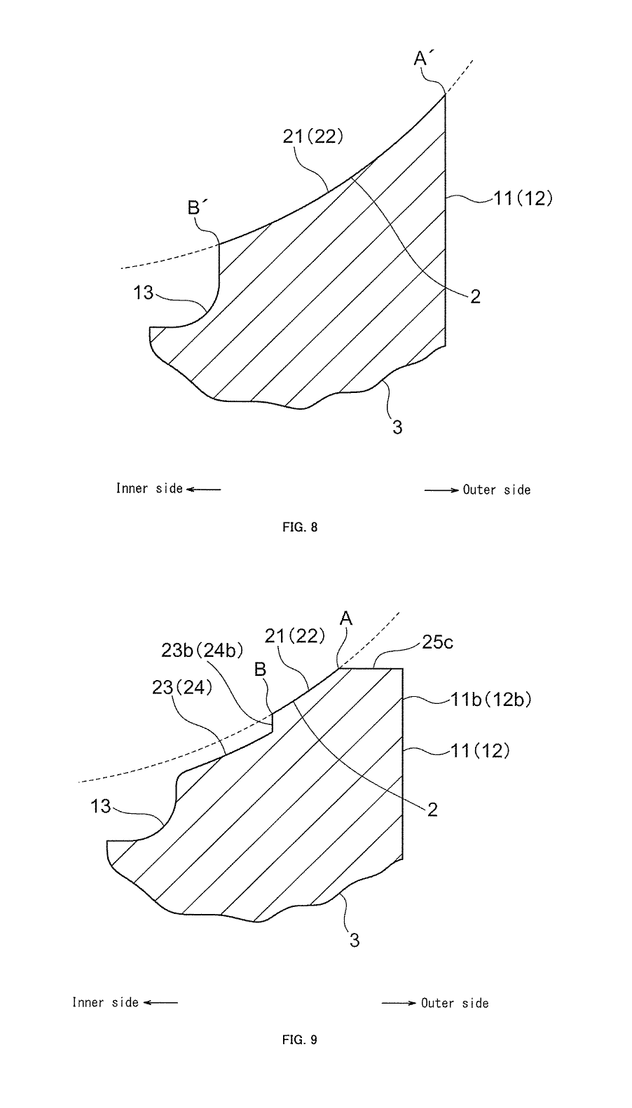

Furthermore, as shown in FIG. 8, the supporting parts 11, 12 themselves may form the contact surfaces 21, 22, and the recess section 13 may be the same as the different level section. In this case, the contact surface area of the contact surfaces 21, 22, in other words, the surface area of the region from the edge portion A′ to the edge portion B′ shown in FIG. 8 is approximately the same as the first embodiment (the surface area of the region from the edge portion A to the edge portion B shown in FIG. 3).

Moreover, as shown in FIG. 9, it is also possible to form only 23b as a side wall surface, and the side wall surface 25a (see FIG. 3) may be omitted.

In the first and second embodiments, the moving element is a rotor which performs rotational movement, but the moving element may be used in an ultrasonic motor which performs linear movement.

In the first embodiment, the shape of the rotor is a cylindrical shape, but may also be an elliptical cylindrical shape.

In the second embodiment, the shape of the stator is a circular ring shape, but may also be an elliptical ring shape.

1-8. (canceled)

9. An ultrasonic motor, comprising:
a moving element which performs rotational movement or linear movement;
a fixed element which has a contact surface capable of making surface contact with the moving element and which causes the moving element to move;
a pre-loading means which presses the moving element against the fixed element; and
a vibration means which causes the moving element to move by generating ultrasonic vibrations in the fixed element,
wherein a different level section is formed in the fixed element in the vicinity of the contact surface so as to form a gap between the fixed element and the moving element, and
the fixed element has a supporting part in which the contact surface and the different level section are formed.

10. The ultrasonic motor according to claim 9, wherein the different level section has a bottom forming surface which is away from an outer circumferential surface of the moving element, and a side wall surface which links the contact surface with the bottom forming surface.

11. The ultrasonic motor according to claim 10, wherein the bottom forming surface has a circular arc-shaped cross-sectional shape following the outer circumferential surface of the moving element.

12. The ultrasonic motor according to claim 10, wherein the side wall surface is formed so as to extend in the direction in which the moving element is pressed against the fixed element.

13. The ultrasonic motor according to claim 9, wherein the different level section functions as an oil groove for drawing lubricant in between the outer circumferential surface of the moving element and the contact surface.

14. The ultrasonic motor according to claim 9,
wherein the moving element performs rotational movement, and an outer surface of the moving element has a cylindrical shape, and
the fixed element has at least two supporting parts extending along an axial direction of the moving element.

15. The ultrasonic motor according to claim 9,
wherein the moving element performs rotational movement, and an outer surface of the moving element has a spherical shape, and
the fixed element has the supporting part formed in a substantially circular ring shape.

16. The ultrasonic motor according to claim 9, wherein the fixed element is provided with a recess section between the fixed element and an outer circumferential surface of the moving element, and has a supply body which supplies lubricant to the contact surface, in the recess section.
